(19) United States
(12) Patent Application Publication
(10) Pub. No.: US 2009/0276530 A1
(43) Pub. Date: Nov. 5, 2009

(54) Devices, Systems, Methods and Software for Computer Networking

(76) Inventors: Darrell Gentry, Mountain View, CA (US); Nathan Burns, San Francisco, CA (US)

Correspondence Address: HARNESS, DICKEY, & PIERCE, P.L.C, 7700 Bonhomme, Suite 400, ST. LOUIS, MO, 63105, US

(21) Appl. No.: 12/325,819

(22) Filed: Dec. 1, 2008

Related U.S. Application Data
(60) Provisional application No. 60/991,309, filed on Nov. 30, 2007.

(51) Int. Cl. G06F 15/16

(52) U.S. Cl. 709/227; 709/238

(57) ABSTRACT

A method of accessing content from a server using a client device, the client device having at least first and second connections to one or more remote computers. The method includes testing the performance of the first connection, testing the performance of the second connection and selecting, in response to the performance testing, the first connection or the second connection for accessing content from the server using the client device.

### CROSS REFERENCE TO RELATED APPLICATION

This application claims the benefit of U.S. Provisional Application No. 60/991,309 filed Nov. 30, 2007, the entire disclosure of which is incorporated herein by reference.

### BRIEF DESCRIPTION OF THE DRAWINGS

FIG. 1 illustrates one example of a software program for a client computing device according to the present disclosure.

FIG. 2 illustrates one example of a client computing device using a physical connection to a network access provider to establish a virtual connection to a bypass network.

FIGS. 3A-3K illustrate details of another embodiment which employs a desktop client for testing and selecting among available connections, as well as a bypass network configured to test and select one or more optimal egress gateways for accessing one or more remote video game servers.

### DESCRIPTION

### Selecting a Connection for use by a Computer Device

A computing device may have one or more physical connections and/or one or more virtual connections to computer network(s). A user of the computing device may desire access to data from a remote server. According to the present disclosure, the performance of accessing the remote server via the one or more physical connections and/or the performance of accessing the remote server via the one or more virtual connections are tested. Based on the test results, and possibly user-defined rules as well, one of the physical or virtual connections is selected for accessing content from the remote server using the computing device. Alternatively, one of the physical or virtual connections can be selected based solely on user-defined rules.

As noted above, a client computing device can have one or more physical connections and/or one or more virtual connections to one or more IP communications networks. The client computing device may be, for example, a personal computer, a home broadband router, a game console, etc. The physical connection(s) may be a fiber, cable broadband, DSL, wireless, satellite, modem/dialup or other connection to a network access provider. The virtual connection(s) may be tunnels established between the client computing device and the IP communication network(s) through a physical connection. The tunnel(s) may be established using a tunneling protocol (to establish a virtual connection through a physical connection) such as Internet protocol 4 (also referred to as “ipencap” or “IP within IP tunneling”) or other suitable means.

The client computing device is preferably configured (via software, an integrated circuit or otherwise) for testing the performance of accessing a remote server via one or more physical connections, and for testing the performance of accessing the remote server via one or more virtual connections. This testing can be performed by the client computing device on its own or in cooperation with one or more other computer devices, including computer devices residing on the IP communications network(s). Based on the test results, and optionally user-defined rules as well, one of the physical or virtual connections is selected for accessing content from the remote server using the computing device. This selection can be made by the client computing device, or by another computing device in communication with the client computing device. The selected connection is then used for accessing content from the remote server using the client computing device. In some embodiments, the selection is made before a connection is established for routing data (other than performance testing data) between the client computing device and the remote server, and this selection is not changed before such connection is terminated.

In other embodiments, the client computing device is configured for testing the performance of accessing the remote server via multiple virtual connections. Based on the test results, and optionally user-defined rules as well, one of the virtual connections is selected for accessing content from the remote server using the computing device. In still other embodiments, one of multiple virtual connections is selected based solely on user-defined rules, without regard to or requiring performance testing.

As noted above, the selection of a particular connection can be based not only on the performance testing, but also in response to user-defined rules. For example, a user may specify that if the latency to a particular server is less than forty milliseconds, the physical connection should always be used (e.g., to avoid usage fees associated with the virtual connection). The same user may also specify, for example, that a virtual connection should be used if latency to a particular server is more than forty milliseconds and the virtual connection is faster than the physical connection, and/or that the virtual connection should always be used if latency to a particular server is more than one hundred milliseconds (e.g., if the virtual connection provides a better user experience, such as less jitter, than the physical connection for especially distant servers, regardless of which is faster). Of course, a user could also specify to always use the fastest connection, or otherwise specify rules and preferences that affect the selection of a particular connection for accessing data from a remote server.

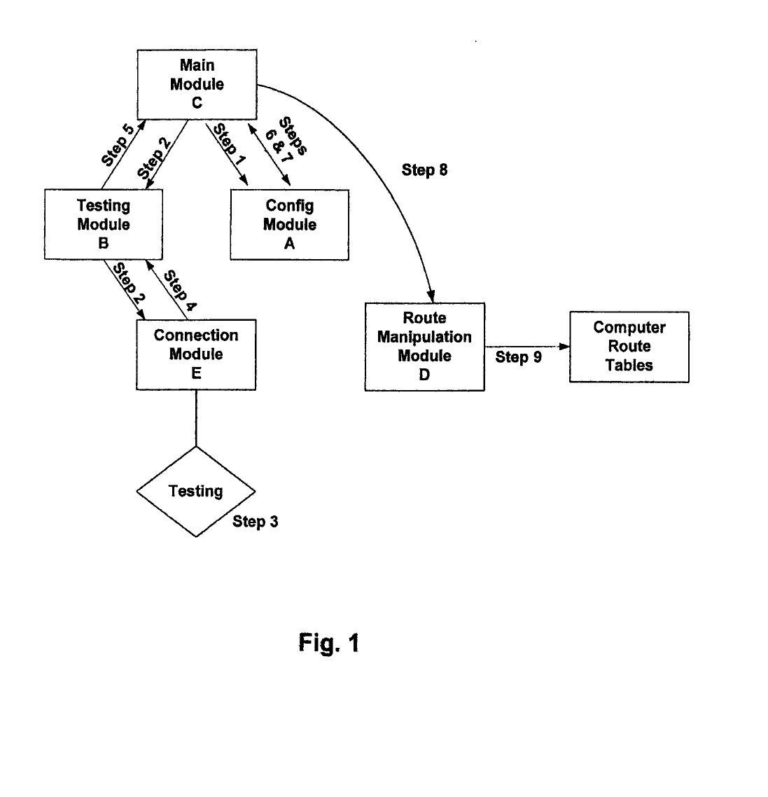

FIG. 1 illustrates one example of a suitable software program for a client computing device. As shown in FIG. 1, the software program includes a configuration module (a), a testing module (b), a main module (c), and a route manipulation module (d). A connection module (e) may also be included within the software program, or the software program may work in conjunction with a connection module (e) previously installed on the client computing device. The configuration module includes location information for remote servers a user wishes to access. This location information may be stored locally on the client computing device, accessed from one or more other computing devices (e.g., in a data center or residing on the Internet), or a combination thereof. The configuration module (and/or other computing device(s)) may also store user-defined rules (which may include user preferences) to be used, in conjunction with the performance testing, for selecting a particular connection. The main module retrieves content from the configuration module (step 1), then orders the testing module to initiate tests to the remote servers that are to be optimized (step 2). The testing module utilizes the connection module to perform tests to the remote servers over the available network options, including one or more physical connections and one or more virtual connections (step 3). Multiple virtual connections may be to separate networks, or could be to different ingress points of the same network. The communications module communicates the test results back to the testing module (step 4). The testing module compiles and formats the tests and communicates the test results to the main module (step 5). The main module requests the user-defined rules from the configuration module (step 6). The configuration module provides the requested data back to the main module (step 7). Based on the user-defined rules, the main module communicates with the route manipulation module to select one of the connections for routing traffic to one of the remote servers (step 8). The router manipulation module then manipulates the route tables of the computing device to cause the computing device to route data to the remote server over the selected connection (step 9). The main module repeats this process until all routes to the remote server have been tested, and may then repeat the entire process after waiting a configurable amount of time.

The testing module may be configured to test, among other things, latency, packet loss, jitter, number of hops (i.e., the number of routers, and thus routing decisions, in a given path), or other factors which impact network performance. Performance tests can be initiated in parallel to different network destinations so that the process of optimizing the routes to those destinations can occur quickly. Further, the testing module may display the outcome of the tests on the computing device display. The testing module may also store the results of previous network tests, either locally on the computing device or at a remote location.

As noted above, the configuration module can include location information for pre-identified servers, which is stored locally, remotely or some combination thereof. Further, the configuration module can capture user-defined rules (including preferences) related to the pre-identified servers. These user-defined rules may include, without limitation, preferred routing parameters to a specific network destination and/or at a specific time of day, for instance during peak usage times or off-peak times, percent differences between options, percent error between network options, etc. For example, if a computing device has a virtual connection and a physical connection, the user-defined rules may specify that if the speeds of the two connections are the same, select the physical connection for accessing content from a remote server, or select the connection with the lowest packet loss. The user-defined rules may also specify that the virtual connection should be used at particular time and/or on particular days. Further, the user-defined rules may indicate that if the latency of accessing a remote server using one connection is within five percent of the other connection, select the physical connection for accessing the remote server (e.g., if using the physical connection costs less than using the virtual connection). Of course, various other user-defined rules can be employed in selecting a particular connection for accessing content from a remote server.

The teachings of this disclosure can be applied to a home router having a single physical connection and at least one virtual connection. In addition to the modules noted above, the home router may also include a network address translation (NAT) rule manipulation module that modifies NAT rules on the home router based on selections and routing decisions made by the other modules to thereby provide access to other computing devices on the home network to the selected network path.

In an alternative embodiment, the software program is configured to work with one or more remote match-maker services, which establish peer-to-peer connections between computing devices. In those applications, the remote server(s) are selected by the match-maker service(s) rather than the user. The configuration module captures the network addresses of the remote servers designated by the match-maker service, and tests performance to such addresses over the physical and virtual connections as described above. Based on the performance tests and criteria contained in the match-maker service, the match-maker service designates the preferred connection for routing data between the client computing device and one of the remote servers. The routing module then routes traffic over the preferred connection(s) to the various remote servers.

### Bypass Computer Network

A bypass computer network allows data communications between a client computing device and a remote content source to be selectively routed around a portion of the public Internet (or other computer network(s)) via the bypass network without requiring a physical connection between the bypass network and either the client computing device or the content source.

In some embodiments, the bypass network is a private Internet Protocol (IP) communications network comprising nodes in two or more geographic locations (e.g., in different cities or States) interconnected by private IP communication links. Each node preferably includes an ingress gateway (for entering the bypass network) and an egress gateway (for exiting the bypass network) that are connected to the private IP communications network and also connected to other public or private network(s), such as the public Internet. Clients of the bypass network connect to (and receive data back from) the ingress gateways using a tunneling protocol (to establish a virtual connection through a physical connection) such as Internet protocol 4 (also referred to as “ipencap” or “IP within IP tunneling”) or other suitable means. These connections allow client data to transit the bypass network. Egress gateways are used when the destination end of the IP communication conversation (e.g., a computer server) is not a client of the bypass network. In that event, traffic is directed from the bypass network to another computer network, such as the public Internet, through the egress gateways (and preferably through the egress gateway positioned closest to the content server) via peering connections between the egress gateways and network routers. The egress gateways may use Network Address Translation (NAT) to provide a return path from the non-bypass computer network (e.g., the Internet) back to the same egress gateway and subsequently through the bypass network back to the originating client. The egress gateways may also use state-full packet inspection to ensure that only outgoing IP conversations are taking place, i.e., that the packets received back by the egress gateway are in response to conversations which originated on the bypass network.

Each client computing device has a physical connection to a data network (e.g., to a network access provider, such as an Internet Service Provider (ISP)). The ingress gateways can work cooperatively with software installed on the client computing devices. The software may be a simple tunneling program to direct traffic to the ingress gateway, or may be an intelligent dynamic or non-dynamic routing program that decides whether and when to use the bypass network for accessing a remote content server (e.g., based on a user selection, user-specified rules, the type of data to be transmitted, the intended data destination, latency to destination, etc.).

The bypass network can have its own physical infrastructure, or it can be a virtual private network operating on the physical infrastructure of one or more other networks, such as the Internet, or it can be a combined physical and virtual network.

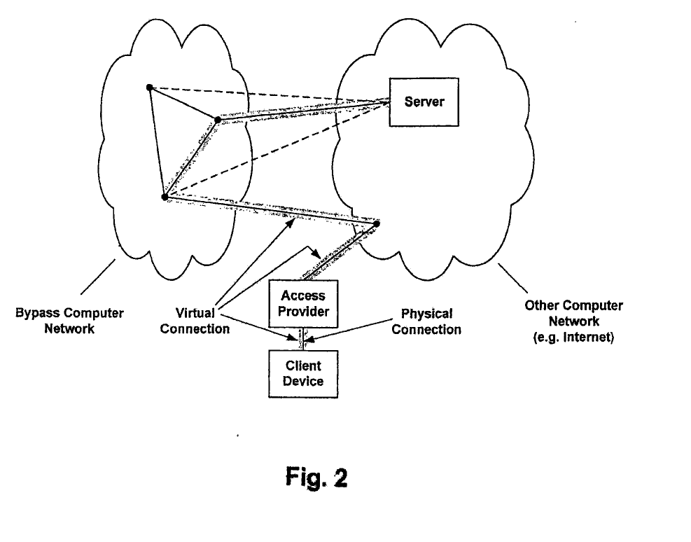

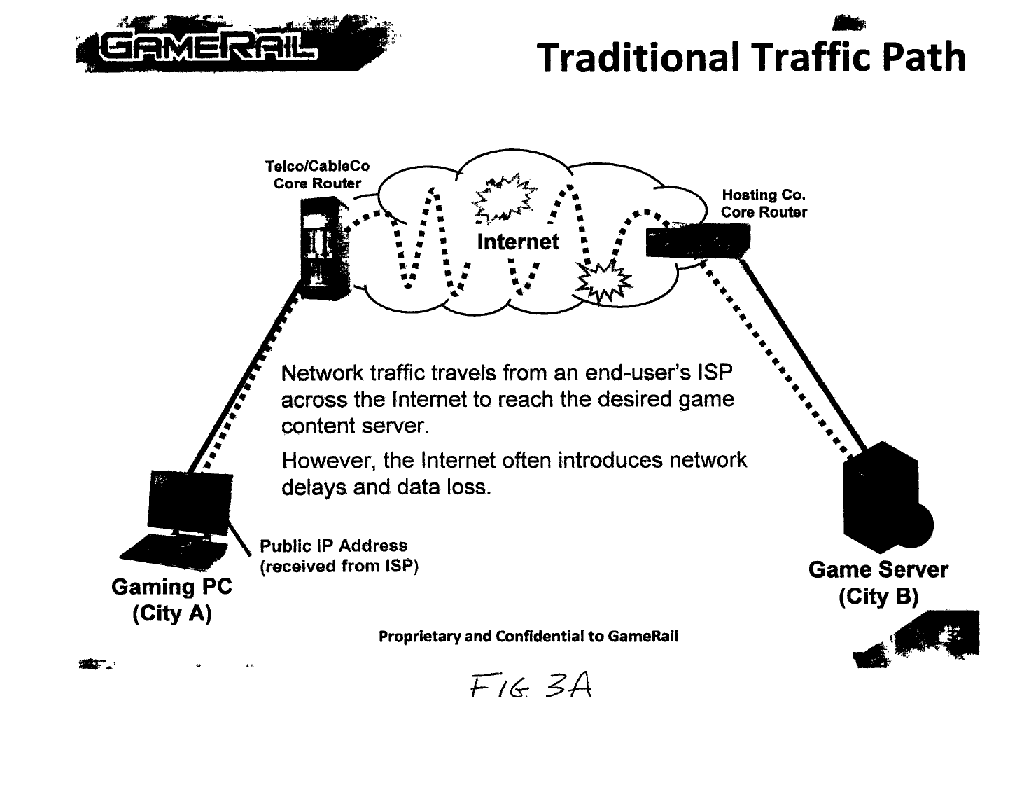

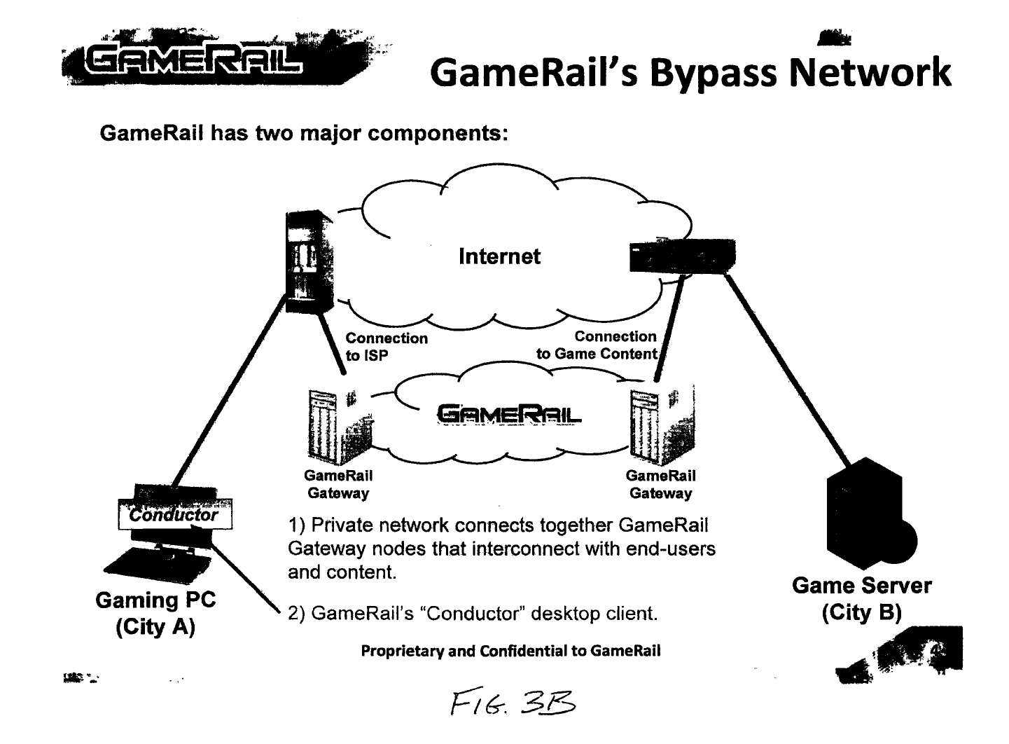

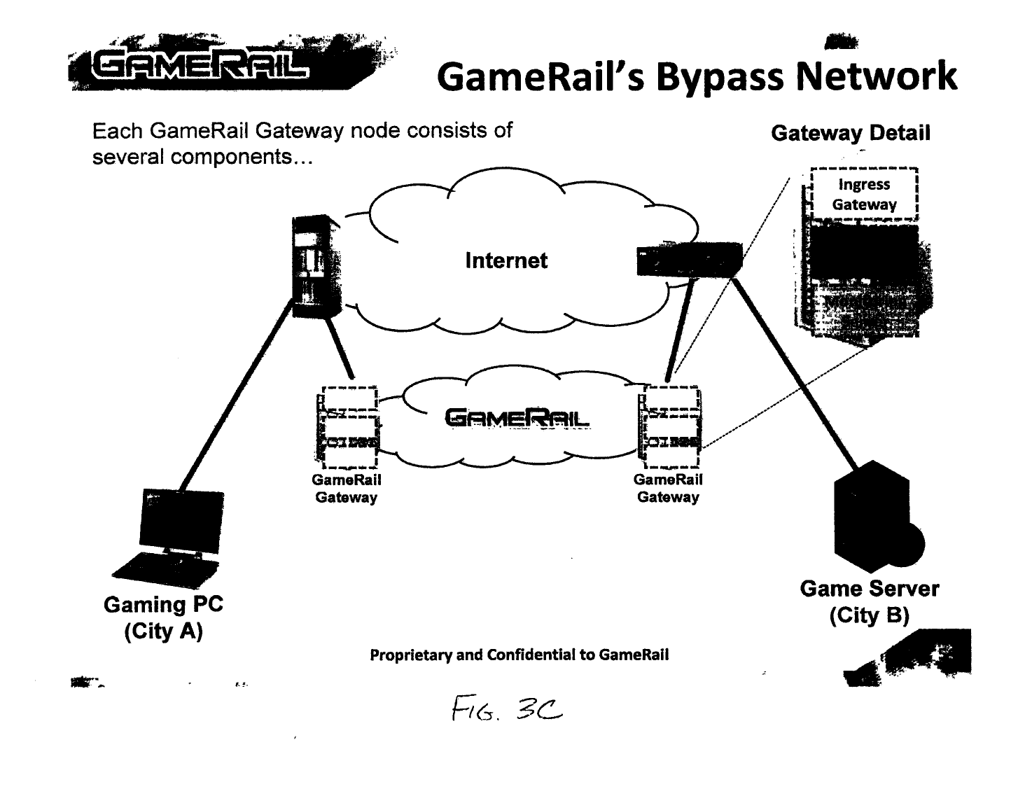

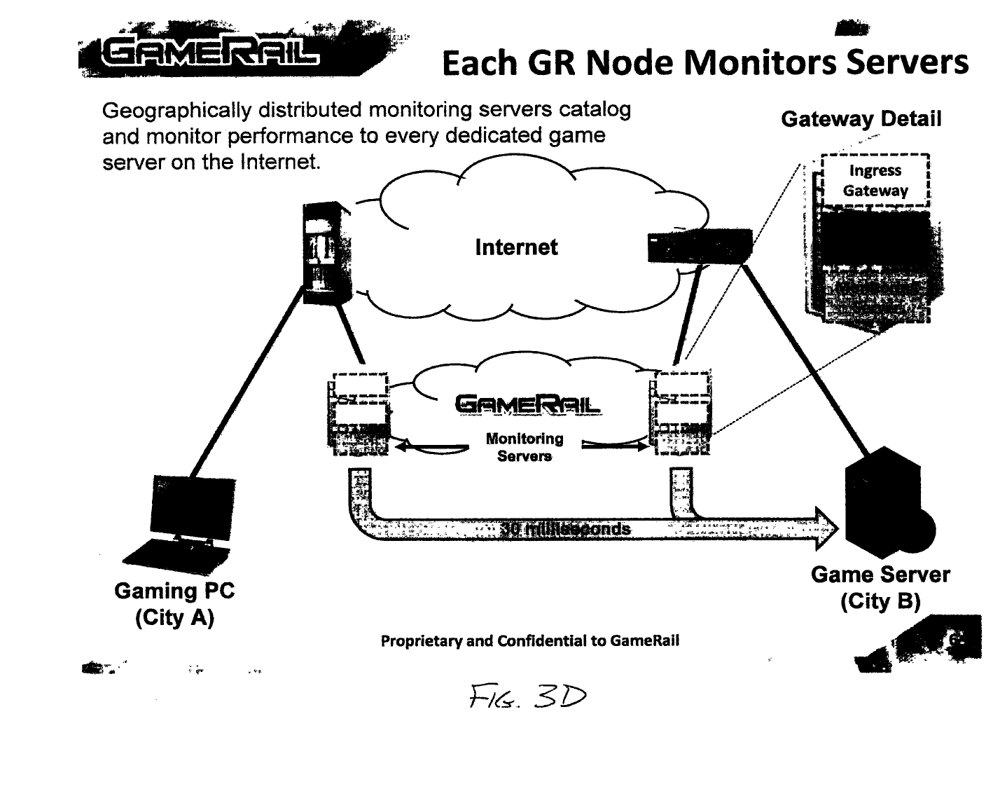

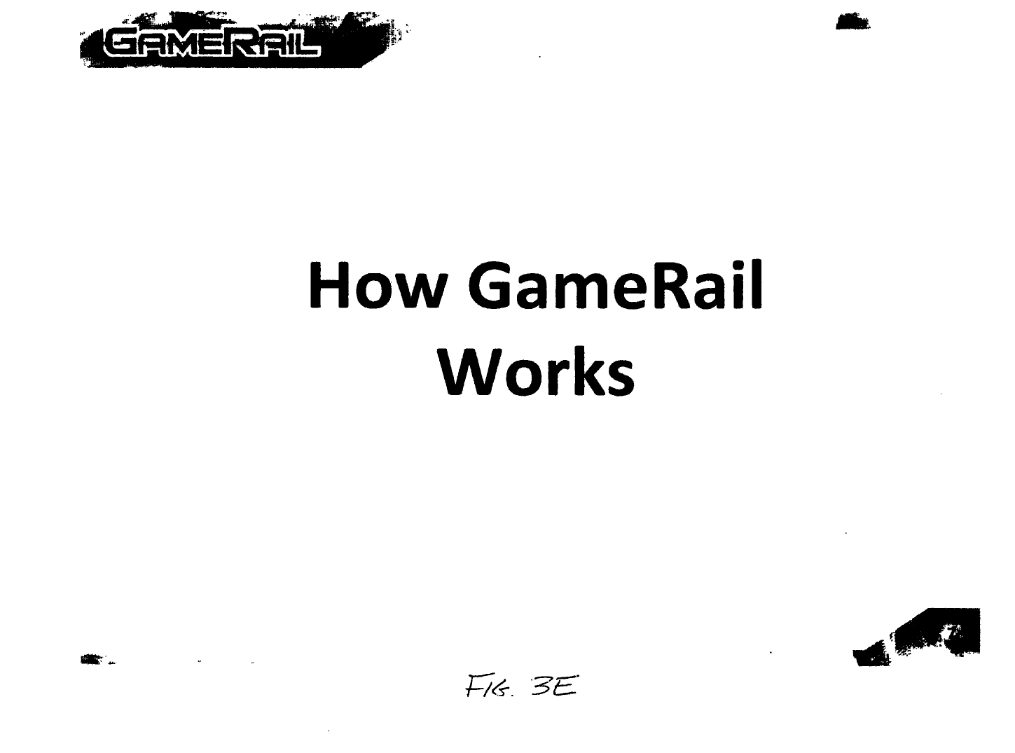

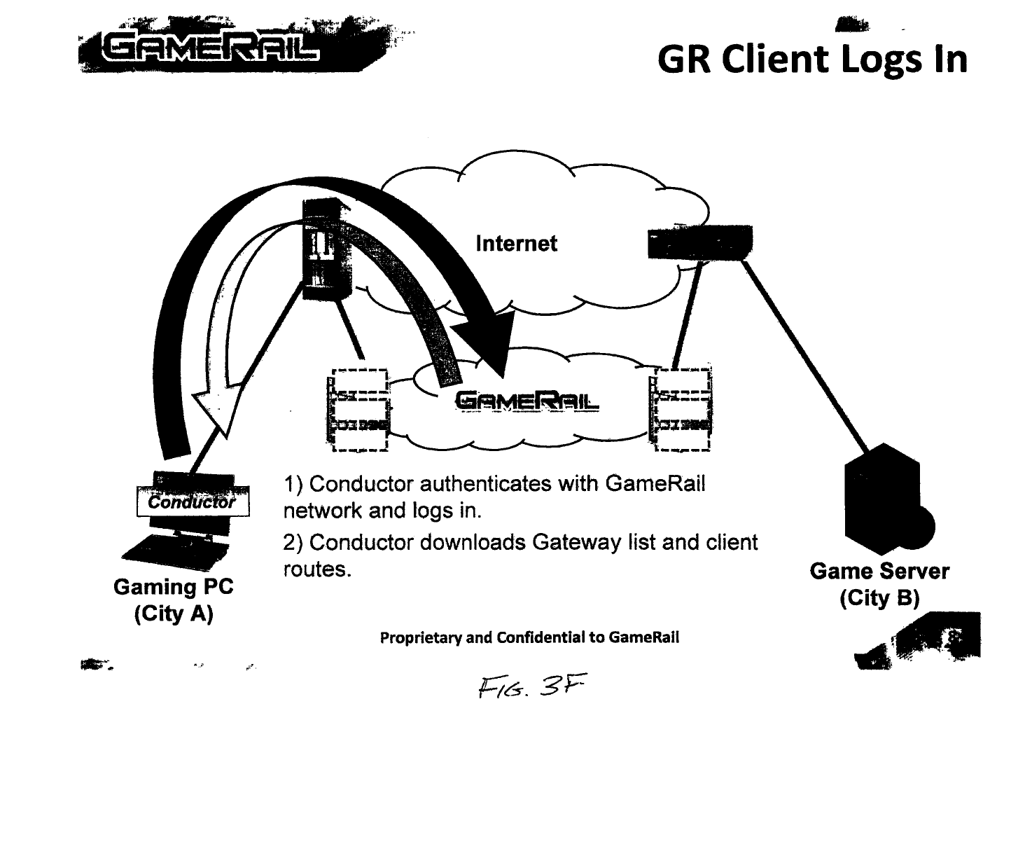

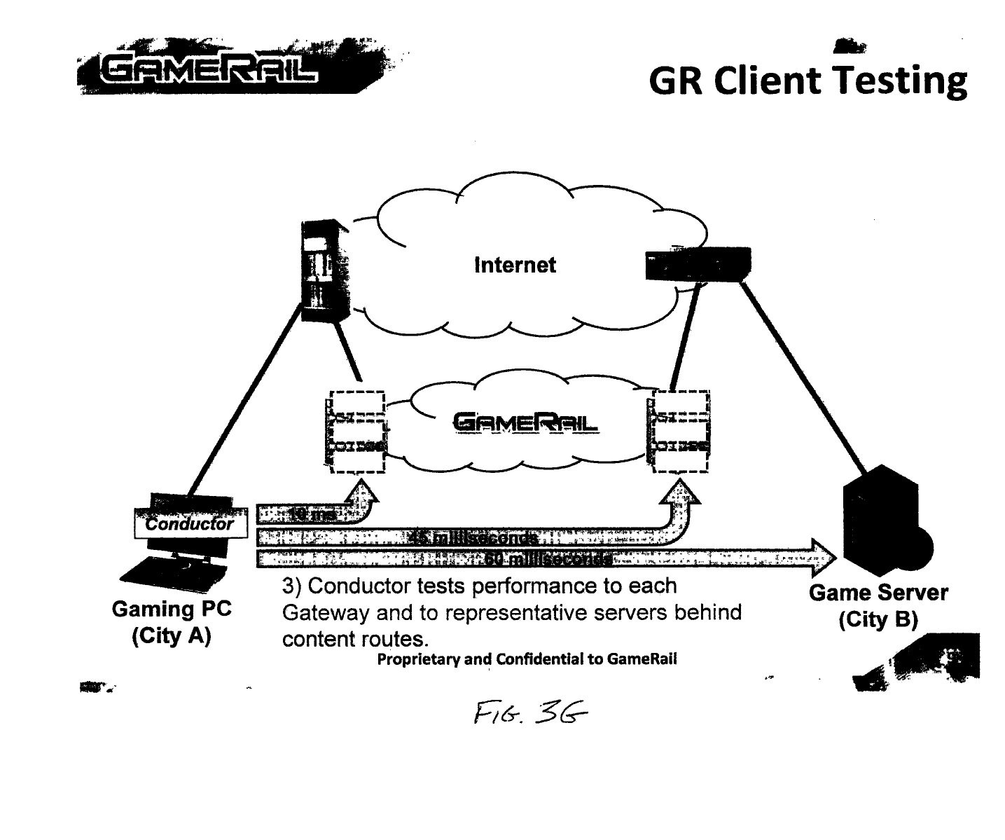

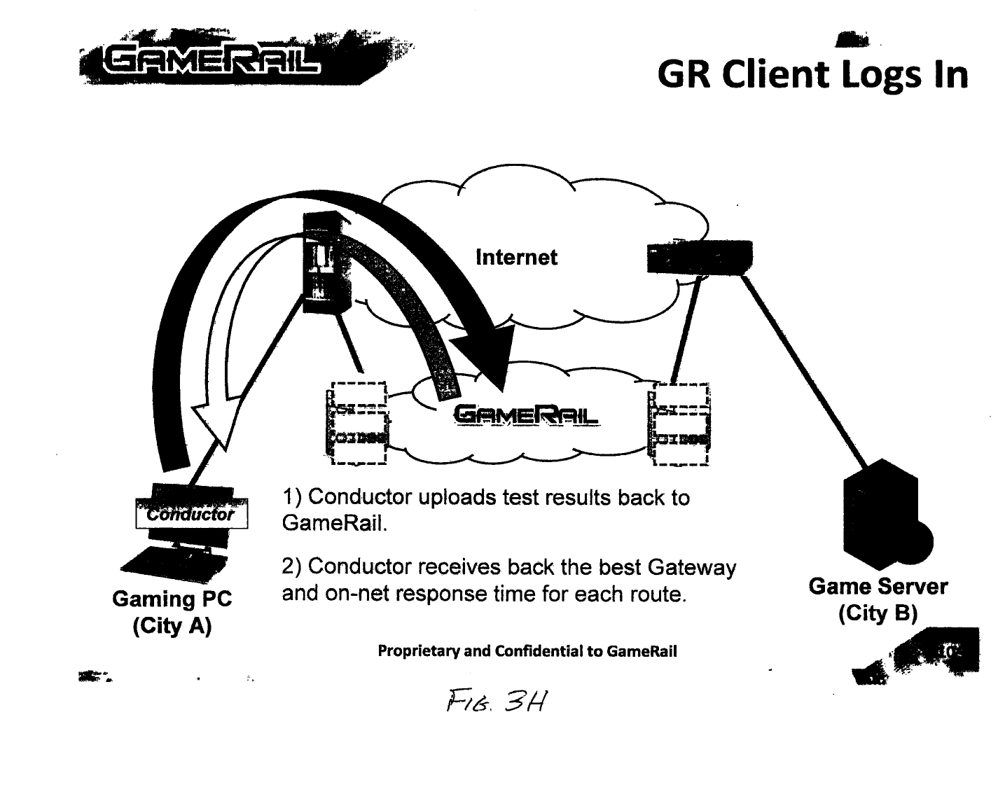

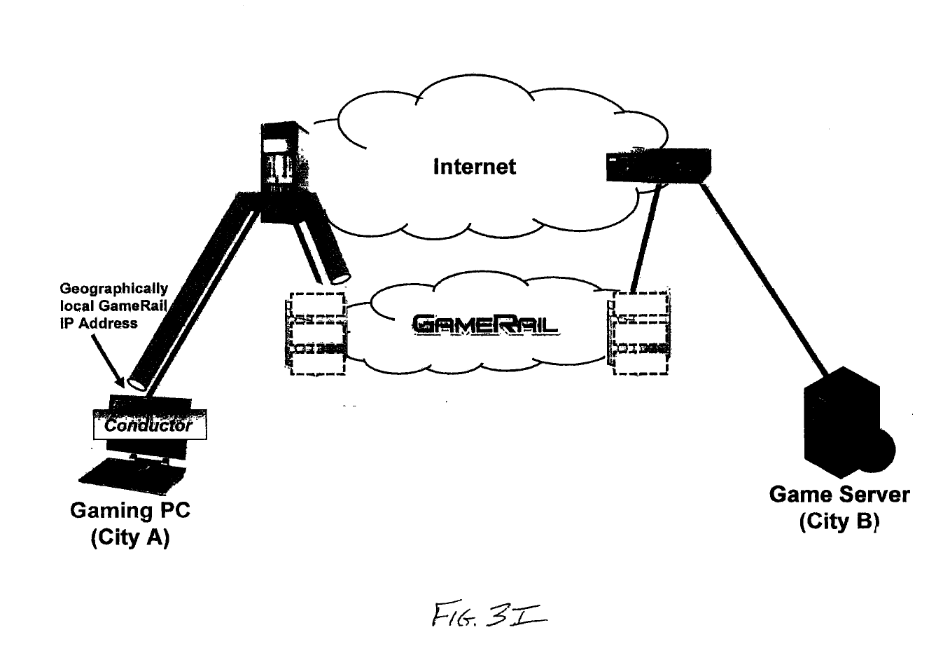

FIG. 2 illustrates one example of a client computing device using a physical connection to a network access provider (e.g., an ISP) to establish a virtual connection to a bypass network. As shown in FIG. 2, the bypass network can receive, via the virtual connection, a data request seeking content from a server residing on another computer network, which may be the Internet. The bypass network routes the data request to the server through a portion of the bypass network and through a portion of the other network (as indicated by the gray line in FIG. 2). The same data path may be and preferably is used for providing the requested data from the server back to the client. While the bypass network is illustrated as a physically distinct network in FIG. 2, it should be understood that the bypass network may be, at least in part, a virtual network operating on the physical infrastructure of one or more other networks, such as the other computer network shown in FIG. 2.

By using the bypass network to route around a portion of the Internet (or other computer network(s)), a client can minimize the data transit path through the Internet (or other computer network(s)) for improved performance (e.g., reduced latency, jitter, etc.) or a more reliable or consistent data communication experience (e.g., more consistent ping times, reduced number of hops between the client and a content server, etc.).

### Identifying a Preferred Egress Gateway in a Bypass Network

A bypass computer network can also be configured to test the performance between each egress gateway and a content server, and to identify at least one preferred egress gateway for accessing the content server based on the testing. The preferred egress gateway may perform Network Address Translation to translate the source IP address of a client seeking data from the content server to a publicly addressable IP assigned to the preferred egress gateway.

The bypass network preferably includes software configured to test the performance between each of multiple egress gateways and a content server, and to identify at least one preferred egress gateway for accessing the content server based on the testing. For example, FIG. 2 illustrates a bypass computer network having three nodes, each of which is capable of accessing the server residing on the other network (as indicated by the dashed and solid lines between the nodes and the server). Before establishing a connection with the client, the bypass network tests the performance between each node and the server, and identifies one of the nodes as a preferred node for accessing the server (the preferred node in FIG. 2 has a solid line between it and the server). Subsequently, when the bypass network receives from a client a request for data from the server, the bypass network routes the data request to the preferred node for accessing the server, as shown in FIG. 2.

In some embodiments, the software includes a testing module, a main module, a route manipulation module, and a network routing table interconnection module. In operation, a client computing device may request data, via the bypass network, from a content server that does not reside within the bypass network. The main module of the software captures the network address of the targeted content server. The main module then polls each egress gateway of the bypass network to identify those egress gateways through which the targeted content server can be accessed. Once potential egress gateways are identified, the testing module initiates a test from each identified egress gateway capable of accessing the content server. The testing may include, for example, determining latency between a given egress gateway and the content server, determining the number of routers (and therefore the number of routing decisions) between a given egress gateway and the content server, determining the physical proximity of a given egress gateway to the content server, etc. The testing module provides the testing data to the main module. Based on this testing data, and possibly pre-defined network preferences as well, the main module designates one of the egress gateways as the preferred egress gateway for accessing the content server. In many cases, this preferred egress gateway will be the egress gateway with the most direct route to the content server. The main module then causes the route manipulation module to populate the internal routing tables of the bypass network with the preferred egress gateway for accessing such content server.

In some embodiments, only one preferred egress gateway is designated for accessing, from within the bypass network, a particular content server in another network (such as the Internet). In other embodiments, multiple preferred egress gateways can be designated for accessing a particular content server in another network, with each preferred egress gateway serving a particular group of clients of the bypass network, or a particular group of ingress gateways. This is because one egress gateway may have the best performance (e.g., the most direct route) for accessing the content server with respect to some but not all bypass network clients and/or ingress gateways.

As noted above, the preferred egress gateway(s) can be designated based on the testing data and pre-defined network preferences. For example, the pre-defined network preferences may indicate that the egress gateway with the lowest latency to a defined content server should be designated a preferred egress gateway. The pre-defined network preferences may also indicate, for example, that if the latencies from multiple egress gateways to a defined content server are equivalent, the egress gateway with the fewest number of routers between it and the defined content server should be designated the preferred egress gateway. The internal gateway protocol of the bypass network will assign internal routes to ingress and egress gateways based on the testing and the pre-defined network preferences.

### Combined Embodiments

Each aspect of the present disclosure can be implemented independently or in combination with one or more other aspects described herein. For example, when selecting a connection for use by a computing device as described above, one or more of the available connections may be a virtual connection to a bypass network. When such a virtual connection is selected for accessing data from a remote server, the bypass network is used to selectively route data communications between the client computing device and the remove server around a portion of the public Internet (or other computer network(s)) via the bypass network without requiring a physical connection between the bypass network and either the client computing device or the content source/remote server. Further, the bypass network can also be configured to test the performance between each egress gateway and a content server, and to identify at least one preferred egress gateway for accessing the content server based on the testing. The preferred egress gateway may perform Network Address Translation to translate the source IP address of a client seeking data from the content server to a publicly addressable IP assigned to the preferred egress gateway.

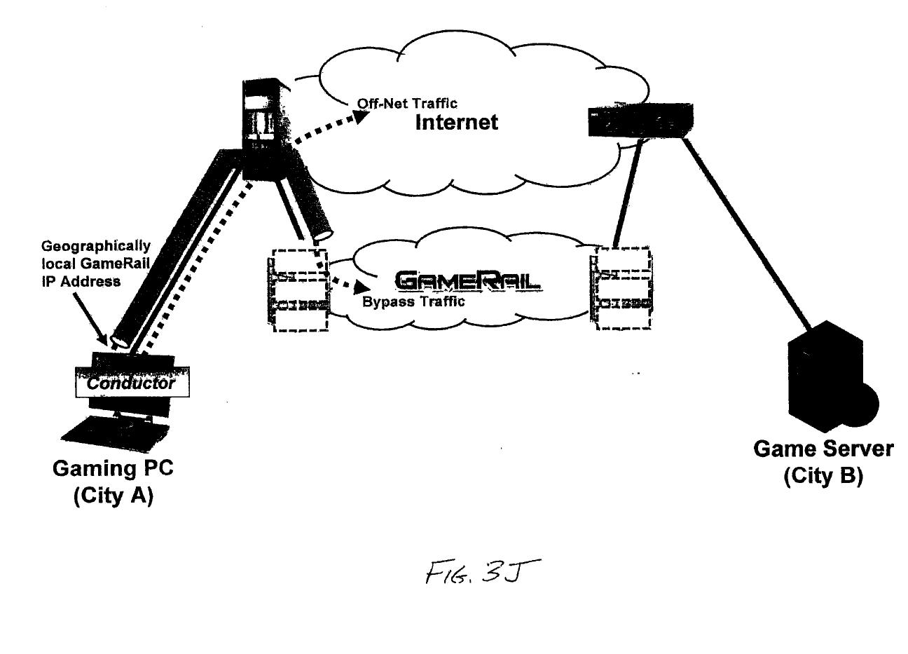

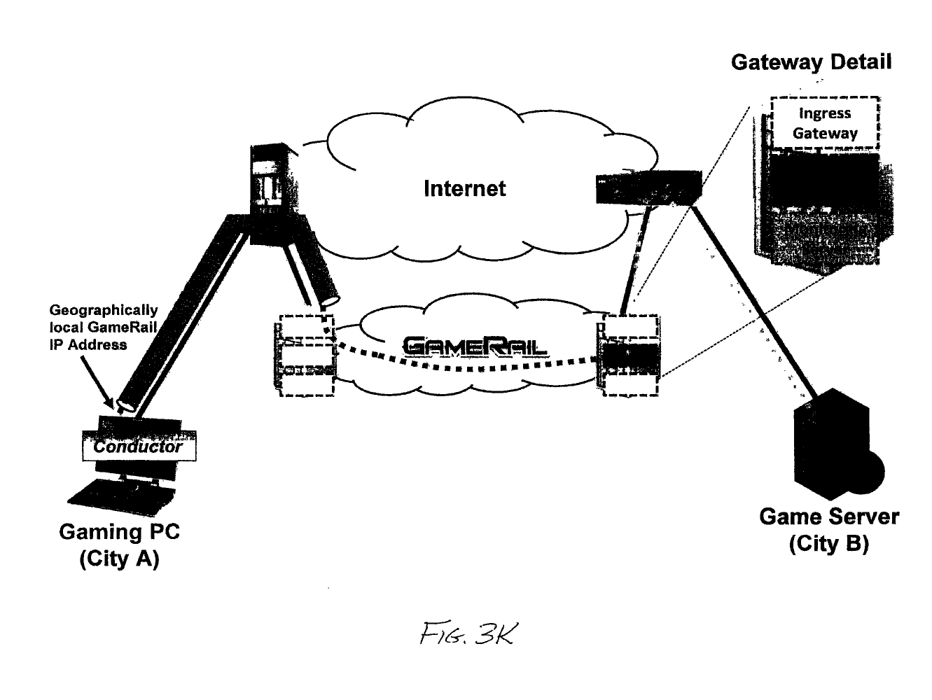

FIGS. 3A-K illustrate details of another embodiment which employs a desktop client for testing and selecting among available connections, as well as a bypass network configured to test and select one or more optimal egress gateways for accessing one or more remote video game servers.

### Conclusion

As noted immediately above, the teachings of this disclosure can be applied, for example, to on-line video gaming applications in which clients communicate with remote video game servers (e.g., in different cities and/or states than the client) over a portion of the Internet. It should be understood, however, that the teachings of this disclosure are not so limited and can be applied to a wide variety of data communication applications.

The above description should be construed as exemplary only and does not describe every possible instance of the system. Numerous alternatives could be implemented, using combinations of current or future technologies, which would still fall within the scope of the claims. For example, different tunneling protocols could be utilized to establish virtual connections or tunnels, or different internet connectivity means could be utilized as the physical connection. Further, the software functionality described above may be embodied in an application-specific or programmable integrated circuit. Further, the bypass network may be a public (rather than private) computer network.

1. A method of accessing content from a server using a client device, the client device having at least first and second connections to one or more remote computers, the method comprising:
testing the performance of the first connection;
testing the performance of the second connection; and
selecting, in response to the performance testing, the first connection or the second connection for accessing content from the server using the client device.

2-16. (canceled)

17. The method of claim 1 wherein the first connection is a virtual connection to a first computer network for bypassing a portion of a second computer network when accessing resources from the second computer network, the method further comprising:
receiving a data request from the client computer via the first connection, said data request seeking content from a server residing on the second computer network; and
routing the data request to said server through a portion of the first computer network and a portion of the second computer network.

18. The method of claim 17 wherein the bypass network includes a plurality of egress gateways capable of accessing the content server, the method further comprising:
testing performance between each egress gateway and the content server; and
identifying at least one preferred egress gateway for accessing the content server based on the testing.

19. A method of accessing content from a server using a client device, the client device having at least first and second connections to one or more remote computers, the method comprising selecting, according to user-defined rules, the first connection or the second connection for accessing content from the server using the client device.

20-21. (canceled)

22. The method of claim 19 wherein the first connection is a virtual connection to a first computer network for bypassing a portion of a second computer network when accessing resources from the second computer network, the method further comprising:
receiving a data request from the client computer via the first connection, said data request seeking content from a server residing on the second computer network; and
routing the data request to said server through a portion of the first computer network and a portion of the second computer network.

23. The method of claim 22 wherein the bypass network includes a plurality of egress gateways capable of accessing the content server, the method further comprising:
testing performance between each egress gateway and the content server; and
identifying at least one preferred egress gateway for accessing the content server based on the testing.

24-49. (canceled)

50. A computer network comprising at least one ingress gateway and one egress gateway, the ingress gateway configured for establishing a connection with one or more clients, the egress gateway configured for establishing a connection with one or more computer servers located in another computer network.

51. The computer network of claim 50 wherein said another computer network is the Internet.

52-64. (canceled)
